(19) United States
(12) Patent Application Publication
(10) Pub. No.: US 2015/0006510 A1
(43) Pub. Date: Jan. 1, 2015

(54) METHOD AND APPARATUS FOR PROVIDING CONVERSATION HISTORY GENERATED FROM MULTIPLE COMMUNICATION CHANNELS

(71) Applicant: VONAGE NETWORK LLC, Holmdel, NJ (US)

(72) Inventors: TZAHI EFRATI, HOBOKEN, NJ (US); ITAY BIANCO, TEL-AIV (IL); BARUCH STERMAN, EFRAT (IL); SAGIE MACHLIN, RISHON LEZION (IL); IDO MINTZ, BURGATA (IL)

(21) Appl. No.: 13/931,338

(22) Filed: Jun. 28, 2013

(51) Int. Cl. G06F 17/30

(52) U.S. Cl. CPC G06F 17/30554
USPC 707/722

(57) ABSTRACT

A method and apparatus for aggregating conversation history comprising collecting one or more communications from one or more communication channels, associating related communications from the one or more communications with each other using a matching algorithm into one or more conversations and presenting an aggregation of the one or more conversations to a user as a conversation history.

### BACKGROUND OF THE INVENTION

1. Field of the Invention

Embodiments of the present invention generally relate to mobile communications and, more particularly, a method and apparatus for providing conversation history generated from multiple communication channels.

2. Description of the Related Art

As social media becomes ubiquitous, modes of communication between participants becomes scattered over various services, websites, mobile applications and computer software applications and through various modes such as audio, video conferencing, short message service (SMS) messaging, email, public postings and the like. Each service records a history of a participant's actions, conversations with other participants, general activity and the like. Combining each individual service's communication histories is inadequate in helping participants understand the broader scope and context of a conversation taking place over a range of services and modes.

For example, recent call history on a mobile phone generally displays when calls are made, received and missed and in some instances provides voicemail indication. However, the recent call history provides no link between a missed call and a voicemail left as a result of the missed call. Mobile phones also do not record call content, and therefore do not have any information regarding what was discussed during a call. While SMS and email implicitly provide a conversation history, no contextual link between the two forms of communication exists, while participants may carry their conversations across these two services. Users of particular services may have multiple phone numbers, emails, or the like, further adding to the difficulty of contextualizing conversations across various modes and media.

Therefore there is a need in the art for a method and apparatus for aggregating conversation history to present a complete picture of a user's communications over a period of time.

### SUMMARY OF THE INVENTION

The present invention generally is directed towards a method and apparatus for aggregating conversation history comprising collecting one or more communications from one or more communication channels, associating related communications from the one or more communications with each other using a matching algorithm into one or more conversations and presenting an aggregation of the one or more conversations to a user as a conversation history.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating an aggregation apparatus for aggregating conversation history in accordance with exemplary embodiments of the present invention;

FIG. 2 depicts a meta-identity of a user of the apparatus of FIG. 1 according to an exemplary embodiment of the present invention;

FIG. 3 depicts a user interface generated by the apparatus of FIG. 1 in accordance with exemplary embodiments of the present invention;

FIG. 4 depicts a computer system in accordance with at least one embodiment of the present invention; and

FIG. 5 is a flow diagram depicting a method for aggregating conversation history in accordance with exemplary embodiments of the present invention.

### DETAILED DESCRIPTION

The present invention is directed to a method and apparatus for aggregating conversation history. A person may engage in several conversations in a short time period during an average day. In some instances, a single theme may occupy the majority of several conversations. For example, a person may email one of their contacts and discuss some matters, for example, lunch options, over email. Subsequently, the person may initiate a phone call to the contact and establish where they are meeting for lunch. Later, a text message may be exchanged with some further details concerning the timing of the meeting.

The present invention allows for various communication channels, such as email accounts, text messaging accounts and phone calls to be associated together a single “conversations” depending on their content. As described in the example above, the initial emails, the phone call and the text messages exchanged are associated with each other. Subsequently, anyone, usually the initiating person, may view a conversation history showing each aggregation of communications, so that a party may easily view all related details of a conversation in a single interface as opposed to accessing disparate application histories.

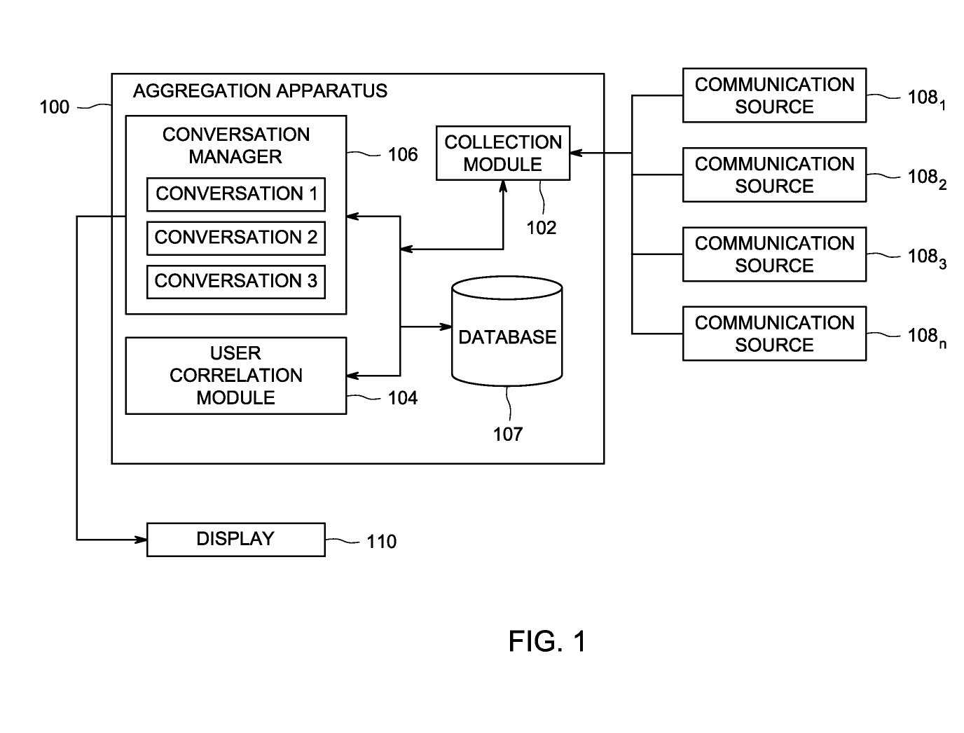

FIG. 1 is a block diagram illustrating an aggregation apparatus 100 for aggregating conversation history in accordance with exemplary embodiments of the present invention. The aggregation apparatus is comprised of a collection module 102, a user correlation module 104, a conversation manager 106 and a database 107. According to some embodiments, the individual modules of the aggregation apparatus 100 may be located remotely from each other. In other embodiments, the modules of the apparatus 100 may be co-located, or the location of the modules may be efficiently configured based on external considerations such as server space, administrator preference, facility space, or the like.

A user of the apparatus 100 may register various communication channels 108₁ to 108ₙ with the apparatus 100, and more specifically, the collection module 102. The collection module 102 polls the communication channels 108₁ to 108ₙ to retrieve any new data on those services. The communication channels 108₁ to 108ₙ may comprise an email service, a text message service, calendar services, a telephone service for making and receiving phone calls and leaving voice-mails, social media services such as FACEBOOK, TWITTER, INSTAGRAM and the like. In some instances, the user of apparatus 100 may register his or her mobile device as a communication source and all accounts from the mobile device will be registered with the collection module 102 as a result of the device registration. For example, if a user has a mobile device for using GMAIL, sending text messages and making voice calls, the GMAIL account, text messages and voice plan will all be registered with the collection module 102. Additionally, users may configure the apparatus 100 to record conversations between two parties in an in person meeting, resulting from a calendar meeting entry. Detection of an in person meeting may be performed using GPS comparisons, analyzing WiFi history or the like.

The collection module 102 will then periodically poll the communication channels to retrieve updated data. In addition, the sources 108₁ to 108ₙ may push updates to the collection module 102 if the collection module 102 has registered for updates from the sources 108₁ to 108ₙ. As in the above example, the collection module 102 performs application programming interface (API) calls to the various services, for example, GMAIL, to retrieve data for the user. Text messages and voice call content, time, and other metric information are retrieved similarly. In instances where users may have multiple “identities”, for example, the user may have multiple email addresses, the user registers each identity with the collection module 102, facilitating the retrieval of data from the various accounts related to the identity, such as all registered email accounts. Accordingly, a user carrying a single conversation between identities (for example, multiple email addresses) and a phone call and may still view a conversation history fully depicting the user's conversations.

The collection module 102 is coupled to the conversation manager 106. The conversation manager 106 is responsible for collating all of the conversational data retrieved by the collection module 102, and creating and updating conversations. The conversation manager 106 will maintain multiple conversations, where a “conversation” is a logical collection of various emails, text messages, telephone calls, video calls, calendar entries, status updates, tweets, or the like, with a common theme, subject or tag. In some embodiments, a user may tag related communications manually and aid the conversation manager 106 in ordering the various conversations a user may have, across different communication channels and across different user “identities”. In some embodiments, external information such as related phone numbers, websites, images, videos or the like may be associated with the conversation if the external information has been referenced or suggested by one of the communications in the conversation, or the external information is accessed as a result of one of the communications in the conversation.

According to some embodiments, the data collected by the collection module 102 is sorted/associated with a particular conversation according to textual content, voice content, tags, or the like by the conversation manager 106. For example, if a user initiates an email discussing lunch at “Villa Pizza” with a first, second and third recipient and then several hours later sends a text message to the email recipients which states “Let's meet at Villa Pizza at 1 pm”, the conversation manager will create a new conversation, “conversation 1” and associate the original email and the text message with conversation 1 because of the matching text. Similar words in parsed textual and voice communications may indicate that two communications are related and should be included in the same conversation. For example, Villa Pizza may initiate a call later indicating the pizza is ready for the user and his lunch-mates. The calling party is determined as Villa Pizza, and the call content contains audio data about pizza. The conversation manager 106, based on those two pieces of information, relates the communication from Villa Pizza to the user with the other communications, in the same “conversation 1”. If user's later accessed web sites or other external resources are related to “Villa Pizza”, these items may also be tagged as a part of the ongoing conversation 1 by the conversation manager 106.

In some embodiments, the data collected by the collection module 102 is related to or associated with a particular conversation according to time and date of the communication in addition to the content of the communication by the conversation manager 106. To use the above example, if there was an additional phone call made from the user to the second recipient mentioning “Villa Pizza” at 5 pm one day after the text message, this phone call would not be associated with “conversation 1” because the phone call took place significantly after the text message. Accordingly, the conversation manager 106 has a configurable time threshold which acts as an elastic threshold of time until a communication can be considered as part of an ongoing conversation. If the communication falls outside of that threshold, for example, 7 hours, the conversation manager 106 will create a new conversation, e.g., “conversation 2” and store communications related to the phone call at 5 pm in conversation 2.

In some embodiments, the conversation manager 106 may relate communications between different parties that take place as a result of communications between an initiator of a communication. For example, breakout sessions from a meeting over audio phone calls, text messages, or the like are related to the conversation by conversation manager 106. Accordingly, a group of users may pool their communication data sources in order to create collaborative conversations.

All conversations are stored on database 107. In addition, users and user identities, credentials, and the like are stored in database 107. In some instances, the database 107 may be collocated with the apparatus 100, or located remotely from the other modules in apparatus 100. The database 107 may be a relational database, or any other type of database known to those of ordinary skill in the art.

The user correlation module 104 is coupled to the conversation manager 106, the collection module 102 and the database 107. According to exemplary embodiments, the user correlation module 104 creates and manages user accounts and identities, adding communication channels, managing permissions and uploading user contact information to store in database 107.

Once the conversation manager 106 has generated and organized various communications into conversations, such as conversation 1, conversation 2 and conversation 3, the conversation manager 106 generates a user interface allowing a user to access the conversations and their contents. The user interface is rendered on display 110, where display 110 may be a mobile display, a monitor, a television or the like.

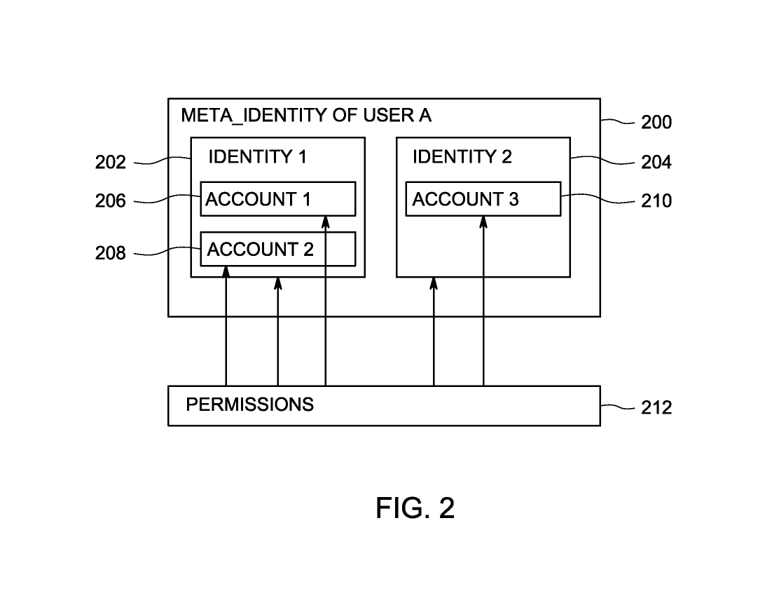

FIG. 2 depicts a meta-identity 200 of a user of the apparatus of FIG. 1 according to an exemplary embodiment of the present invention. For example, when a user would like to register an additional account for the collection module 102 to mine data from, the user supplies the authentication or access information to the user correlation module 104. Alternatively, the user may permit third party applications to register with the collection module 102. The collection module 102 then retrieves data from the account based on authentication or permission data from the user correlation module 104. The user correlation module then creates a meta-identity 200 stored in database 107 associated with the user “A”.

The meta-identity contains a first identity 202 and a second identity 204. The first identity 202 contains various accounts, such as a first account 206 and a second account 208. As described above, these accounts may be email accounts, social media accounts, Voice over Internet Protocol (VoIP) accounts, text messaging accounts or the like. Similarly, the user's second identity 204 may contain just one account 210. Account 210 may be an alternate email account, text messaging account, video conferencing account, or the like.

The user may enable permissions 212 on an account by account basis, or on a user identity basis. For example, a user may only want emails with particular tags attached to them to be retrieved by the collection module 102 for a certain user identity. However, the user may allow the collection module 102 to freely extract account data for other identities. The user correlation module 104 associates user identities with accounts and permissions 212 for those accounts. Additionally, the user correlation module associate the various user identities with the meta-identity 200 of the user.

As communication channels are polled and the conversation manager 106 creates and updates conversations in the database 107, the conversation manager 106 also outputs a display of the conversation history of a user to the display 110. For example, if there are several conversations in the database 107, these conversations are presented to the display 110 in a comprehensible form for the user to view, expand, and review the contents of each communication which composes the conversation. Conversations may be deleted, archived, categorized or the like. By enabling display of conversation histories, the user is able to view their various conversations across different communication channels and different identities easily and quickly identify important content and conversations.

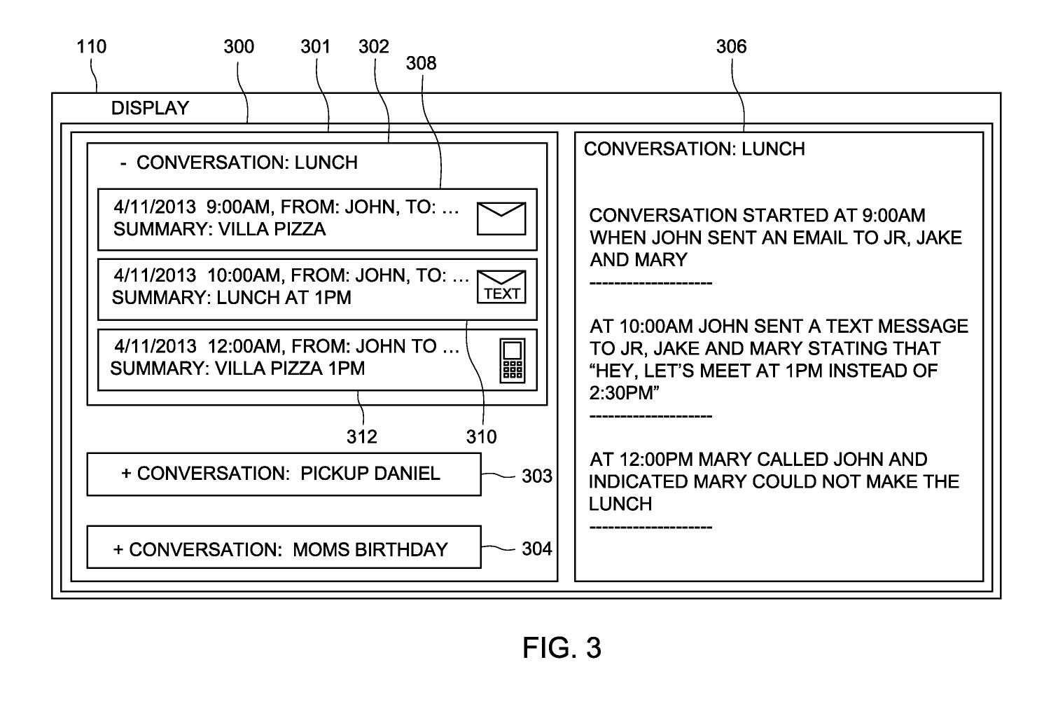

FIG. 3 depicts a user interface generated by the apparatus 100 of FIG. 1 in accordance with exemplary embodiments of the present invention. The display 110 presents a user interface 300 to a user. The display 110 may be a computer monitor, a mobile device screen, a tablet display, a television display, a laptop display or the like. The interface 300 is an exemplary interface providing conversation history of all conversations for a user created or updated by the conversation manager 106. Those of ordinary skill in the art would recognize that the configuration shown in FIG. 3 is merely exemplary and is configurable by the user to suit the user's particular needs. The interface 300 may also be configured to dynamically render itself according to the type of display 110 being used by the user.

According to one embodiment, the interface 300 is composed of a left pane 301 and a right pane 306. The left pane 301 may contain, for example, a listing of conversations the user has had during the past day. The user may configure the elastic period of conversation history to display, for example, anywhere from a time span of several hours, to several months. Alternatively, the user may configure the interface 300 to merely display the most recent conversations. In FIG. 3, three conversations are shown. First conversation 302 is expanded to show the individual communications with a given summary of each communication. Second conversations 303 and third conversation 304 respectively are not expanded, but may be expanded to display a similar summary.

When the user selects first conversation 302, the right pane 306 displays the details of all communications collected by the collection module 102 and related to each other by the conversation manager 106. The pane 306 displays details of each communication, for example, the conversation is summarized as being related to “Lunch”. The conversation began when John sent an email to JR, Jake and Mary at 9:00 AM on Apr. 11, 2013, shown as a first communication 308 in the left pane 301. At 10:00 am, John then sent a text message to all the recipients indicating that the lunch meeting should be moved to 1:00 pm instead of 2:30 pm. This text message is shown in the right pane as a second communication 310. Finally, a third communication 312 is stored showing that a phone call was received by John from Mary indicating that Mary could no longer make the lunch.

In some instances, the entirety of the conversation can be viewed by selecting the communication summary of each individual communication. For example, a user may select first communication 308, second communication 310 or third communication 312 to view the actual text, or hear a voice recording, of the communication, respectively to further inspect the communication. From this interface 300, a user may also tag particular communications.

According to some embodiments, if multiple users are pooling their communication channels, the first conversation 302 may, for example, contain threaded communications. The first communication 308 may have resulted in several text messages, emails, audio calls, or the like, between different parties. The first communication 308 then may be expanded and those breakout conversations may be viewed via the first communication 308.

For example, if the user expands second conversation 303 and identifies an email that was actually a part of the first conversation 302, the user may tag, or move, the conversation to first conversation 302. In some embodiments, the user may also provide a reason as to why the communication belongs in first conversation 302 instead of second conversation 303. The conversation manager 106 may then take the categorization into account when creating and updating future conversations for the user. According to some embodiments, the conversation manager 106 may assign a low-priority value to communications deemed to be of lesser value. For example, replies which consist simply of simple platitudes such as thank you, or emoticons, may be ignored, or “grayed out” because of their low priority value.

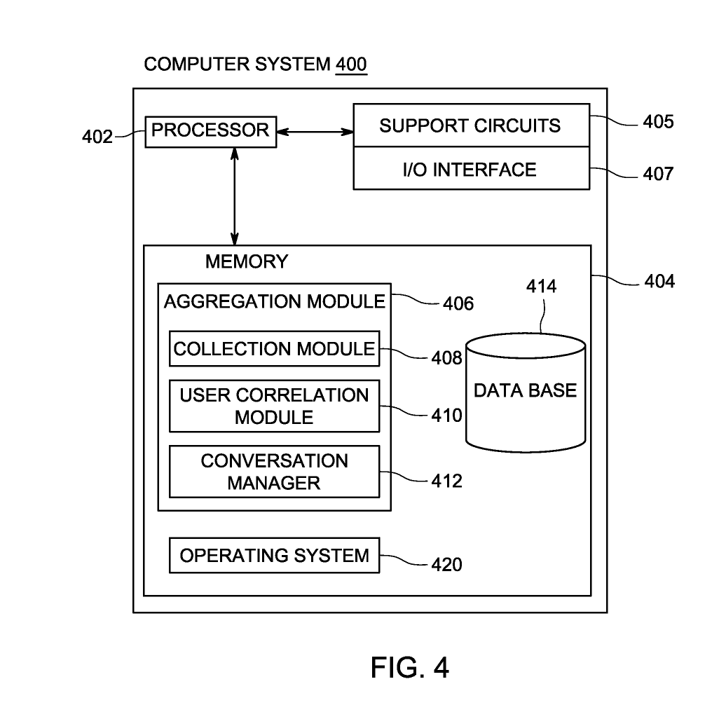

FIG. 4 depicts a computer system 400 in accordance with at least one embodiment of the present invention. The computer system 400 includes a processor 402, various support circuits 405, and memory 404. The processor 402 may include one or more microprocessors known in the art. The support circuits 405 for the processor 402 include conventional cache, power supplies, clock circuits, data registers, I/O interface 407, and the like. The I/O interface 407 may be directly coupled to the memory 404 or coupled through the support circuits 405. The I/O interface 407 may also be configured for communication with input devices and/or output devices such as network devices, various storage devices, mouse, keyboard, display, video and audio sensors, IMU and the like.

The memory 404, or computer readable medium, stores non-transient processor-executable instructions and/or data that may be executed by and/or used by the processor 402. These processor-executable instructions may comprise firmware, software, and the like, or some combination thereof. Modules having processor-executable instructions that are stored in the memory 404 comprise an aggregation module 406 and a database 414. The aggregation module 406 further comprises a collection module 408, a user correlation module 410 and a conversation manager 412.

The computer system 400 may be programmed with one or more operating systems 420, which may include OS/2, Linux, SOLARIS, UNIX, HPUX, AIX, WINDOWS, IOS, and ANDROID among other known platforms.

The memory 404 may include one or more of the following: random access memory, read only memory, magneto-resistive read/write memory, optical read/write memory, cache memory, magnetic read/write memory, and the like, as well as signal-bearing media as described below.

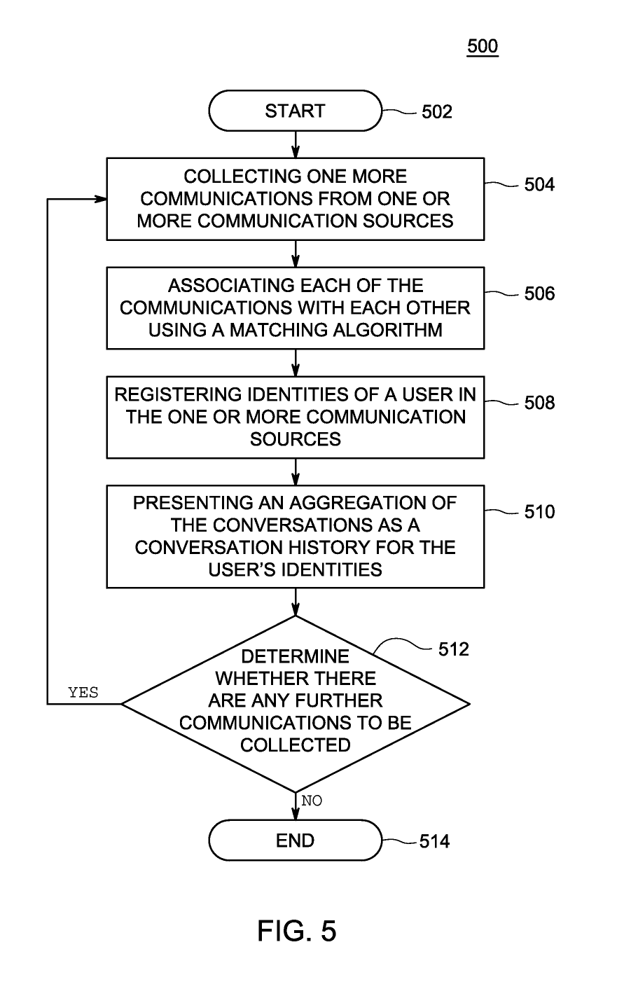

FIG. 5 is a flow diagram depicting a method 500 for aggregating conversation history in accordance with exemplary embodiments of the present invention. The method 500 is an exemplary process flow of the aggregation apparatus 100, implemented as the aggregation module 406, executed on the computer system 400.

The method begins at step 502 and proceeds to step 504. At step 504, the collection module 102 collects one or more communications from one or more communication channels. In some instances, the communication source may be a mobile device or a combination of mobile devices and manually registered services such as email services, text messaging services, video conferencing services, social media services, and the like. The collection module 102 uses the service APIs of these various services to retrieve individual emails, messages, and the like, each considered a “communication”, and stores these communications in database 107 for later evaluation and review.

The method proceeds to step 506, where the conversation manager 106 associates each of the related communications with each other using a matching algorithm. The communications may be deemed “related” when two communications contain the same parties, are sent within a particular predetermined time-frame for relatedness, are tagged similarly, have similarly parsed textual or voice content, the communications are recurring, or some combination of the above. In other instances, the conversation manager 106 may determine that several communications involve several sub-identities of a user meta-identity, and assign a higher correlation between communications of those identities as opposed to other identities.

In other embodiments, the context of originating a communication may be examined, i.e., calling a contact from a dialer's recent call display may indicate that the two conversations are related. The user may also provide feedback to the conversation manager 106 indicating whether particular communications were mis-categorized into an unrelated conversation. The conversation manager 106 creates conversations when two communications are related, and updates the conversation when other related communications are collected by the collection module 102. The conversation and related communication data is stored in database 107. At step 508, various user identities may be registered with the user correlation module 104 and correlated with one or more of the communication channels.

Once the method proceeds to step 510, the conversation manager 106 presents an aggregation of the conversations created by the conversation manager 106 as a conversation history for all of the user identities. The user may also configure which identities to display and a time span and granularity of display. The method 500 then determines at step 512 whether there are any further communications to be collected. If there are further communications to be collected, the method returns to step 504 to collect further communications. Otherwise, the method terminates at step 514.

Those skilled in the art will appreciate that computer system 400 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 400 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 400 may be transmitted to computer system 400 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A method for providing conversation history comprising:
collecting one or more communications from one or more communication channels;
associating related communications from the one or more communications with each other into one or more conversations using a matching algorithm; and
presenting an aggregation of the one or more conversations as a conversation history.

2. The method of claim 1 further comprising:
displaying the conversation history on a display.

3. The method of claim 1 further comprising:
wherein the one or more communication channels comprise communications from one or more channels comprising one or more of email, social media services, text messages, telephone calls, video calls, calendar applications and voice mails.

4. The method of claim 3 further comprising:
registering the one or more communication channels based on user input.

5. The method of claim 3 further comprising:
registering the one or more communication channels enabled on a mobile device.

6. The method of claim 5 further comprising:
accessing one or more of email, messaging, social media, telephone calls, video calls, voicemail and dialer applications from a mobile device to extract communication content.

7. The method of claim 1 wherein associating each of the one or more communications further comprises:
comparing parties involved in each of the one or more communications; and
determining two communications as being related when the parties involved are the same.

8. The method of claim 1 wherein associating each of the one or more communications further comprises:
associating communications from the one or more communications which are tagged with the same tags as other communications.

9. The method of claim 1 wherein associating related communications further comprises one or more of:
parsing the one or more communications and associating the communications when similar words indicating related conversations are identified;
comparing dates and times of each of the one or more communications and proximity of each of the one or more communications amongst each other; and
analyzing context of origination of a communication.

10. The method of claim 1 wherein the matching algorithm in associating each of the one or more communications further comprises:
registering one or more identities of a user; and
associating related communications between the user's one or more registered identities.

11. The method of claim 10 further comprising:
registering identities of contacts of the user; and
performing the associating of related communications based on the registered identities of contacts.

12. An apparatus for aggregating conversation history comprising:
a collection module that collects one or more communications from one or more communication channels; and
a conversation manager that associates related communications from the one or more communications with each other using a matching algorithm into one or more conversations and presents an aggregation of the one or more conversations to a user as a conversation history.

13. The apparatus of claim 12 wherein the conversation manager further displays the conversation history on a display.

14. The apparatus of claim 12 further comprising:
wherein the one or more communication channels comprise communications from one or more of email services, social media services, text messages, calendar applications, telephone calls, video calls and voice mails.

15. The apparatus of claim 14 wherein the collection module further registers the one or more communication channels based on user input.

16. The apparatus of claim 14 wherein the collection module further registers the one or more communication channels enabled on a mobile device coupled to the apparatus.

17. The apparatus of claim 16 wherein the collection module further
accesses email, telephone calls, video calls, text messages, calendar applications and dialer applications from a mobile device to extract communication content.

18. The apparatus of claim 12 wherein the conversation manager further
compares parties involved in each of the one or more communications and determines two communications as being related when the parties involved are the same.

19. The apparatus of claim 12 the conversation manager further associates communications from the one or more communications which are tagged with the same tags as other communications.

20. The apparatus of claim 12 wherein the conversation manager further associates related communications by performing one or more of:
parsing the one or more communications and associating the communications when similar words indicating related conversations are identified;
comparing dates and times of each of the one or more communications and proximity of each of the one or more communications amongst each other; and
analyzing context of origination of a communication.
